(19) United States
(12) Patent Application Publication
(10) Pub. No.: US 2013/0201691 A1
(43) Pub. Date: Aug. 8, 2013

(54) LIGHTING DEVICE WITH SHAPED REFLECTOR

(71) Applicant: Taiwan Network Computer & Electronic Co., Ltd., New Taipei City (TW)

(72) Inventor: Ping-Han CHUANG, New Taipei City (TW)

(73) Assignee: TAIWAN NETWORK COMPUTER & ELECTRONIC CO., LTD., New Taipei City (TW)

(21) Appl. No.: 13/749,024

(22) Filed: Jan. 24, 2013

(30) Foreign Application Priority Data
Feb. 2, 2012 (CN) 201220032664.2

(51) Int. Cl. F21V 7/04

(52) U.S. Cl. CPC F21V 7/048
USPC 362/297

(57) ABSTRACT

A lighting device for street light, lounge light, signboard light or streamline worktable light application to meet energy-saving and carbon-reduction requirements is disclosed to include a light source, a lamp case, a power converter, a shaped reflector for reflecting light rays from the light source toward a predetermined space area to form a rectangular or specially shaped illumination zone, and a light-transmissive material. The shaped reflector includes an inner reflecting surface, two lateral walls respectively formed of a straight line segment structure of an outwardly arched curvature, and opposing front and rear walls respectively providing an outwardly arched curvature. Each outwardly arched curvature consists of multiple inclined faces inclining in such a manner that an upper inclined face inclines toward the center of the shaped reflector at a relative greater angle than one adjacent lower inclined face.

### BACKGROUND OF THE INVENTION

1. Field of the Invention

The present invention relates to a lighting technology and more particularly, to a lighting device with shaped reflector. The shaped reflector of the lighting device has a specially designed reflecting surface for reflecting light rays emitted by the light source of the lighting device toward a predetermined space area, forming a rectangular or specially shaped illumination zone.

2. Description of the Related Art

Regular lighting devices may be equipped with a reflector to reflect emitted light toward a predetermined illumination area. FIG. 1A illustrates one prior art design of lighting device, in which the reflector comprises an arched reflecting surface 101 on the middle, two planar reflecting surfaces 102;103 at two opposite lateral sides, two mounting through holes 104;105 respectively cut through the two planar reflecting surfaces 102;103, and a lamp tube 106 mounted in the mounting through holes 104;105. This design of reflector can reflect emitted light toward a substantially square illumination area.

FIG. 1B illustrates another prior art design of lighting device, in which the reflector comprises a semielliptical reflecting surface 107, a through hole 108 cut through the semielliptical reflecting surface 107 at one lateral side, and a lamp tube 109 mounted in the through hole 108 and suspended on the inside of the reflector. This design of reflector can reflect emitted light toward a substantially elliptical illumination area.

FIG. 1C illustrates still another prior art design of lighting device, in which the reflector comprises a smoothly arched reflecting surface 107 around the periphery, a planar top reflecting surface 111, a through hole 1128 cut through the planar top reflecting surface 111, and a lamp tube 113 mounted in the through hole 112 and vertically suspended inside of the reflector. This design of reflector can reflect emitted light toward a circular illumination area.

The aforesaid prior art designs can simply illuminate a square, elliptical or circular illumination area, not suitable for street light, lounge light, signboard light or streamline worktable light application. If the aforesaid prior art designs are used for street light, lounge light, signboard light or streamline worktable light application to provide the desired brightness, the lighting power density must be relatively increased, causing waste of power.

### SUMMARY OF THE INVENTION

The present invention has been accomplished under the circumstances in view. It is therefore the main object of the present invention to provide a lighting device with shaped reflector, which eliminates the drawbacks of the conventional designs.

To achieve this and other objects of the invention, a lighting device comprises a light source adapted to emit light, and a shaped reflector mounted in the light source for reflecting light emitted by the light source toward a predetermined space area. The shaped reflector comprises: an inner reflecting surface comprising a first stepped, outwardly arched curvature, a second stepped, outwardly arched curvature and a planar wall connected between the first stepped, outwardly arched curvature and the second stepped, outwardly arched curvature, the first stepped, outwardly arched curvature and the second stepped, outwardly arched curvature each comprising a plurality of inclined faces, the inclined faces of the first stepped, outwardly arched curvature inclining in such a manner that one upper inclined face inclines toward the center of the shaped reflector at a relative greater angle than one adjacent lower inclined face, the inclined faces of the second stepped, outwardly arched curvature inclining in such a manner that one upper inclined face inclines toward the center of the shaped reflector at a relative greater angle than one adjacent lower inclined face; two opposing lateral walls, each lateral wall comprising a straight line segment structure formed of a plurality of stepped, outwardly arched curvatures and a connection wall connected between each two adjacent stepped outwardly arched curvatures; a planar top wall; and opposing front wall and rear wall, the front wall and the rear wall being stepped, outwardly arched walls respectively connected between the straight line segment structures of the lateral walls, the front wall and the rear wall being stepped, outwardly arched walls each comprising a straight line segment structure formed of a plurality of stepped, outwardly arched curvatures and a connection wall connected between each two adjacent stepped outwardly arched curvatures.

In an alternate form of the present invention, the lighting device comprises a light source adapted to emit light, and a shaped reflector mounted in the light source for reflecting light emitted by the light source toward a predetermined space area. The shaped reflector comprises an inner reflecting surface comprising an outwardly arched curvature consisting of a plurality of inclined faces, the inclined faces of the inner reflecting surface inclining in such a manner that one upper inclined face inclines toward the center of the shaped reflector at a relative greater angle than one adjacent lower inclined face; two opposing lateral walls, each lateral wall comprising a straight line segment structure formed of the outwardly arched curvature; a top wall; and opposing front wall and rear wall, the front wall and the rear wall being outwardly arched walls respectively connected between the straight line segment structures of the lateral walls and providing an outwardly arched curvature.

In another alternate form of the present invention, the lighting device comprises a light source adapted to emit light, and a shaped reflector mounted in the light source for reflecting light emitted by the light source toward a predetermined space area. The shaped reflector comprises an inner reflecting surface comprising an outwardly arched curvature consisting of a plurality of inclined faces, the inclined faces of the inner reflecting surface inclining in such a manner that one upper inclined face inclines toward the center of the shaped reflector at a relative greater angle than one adjacent lower inclined face; two opposing lateral walls, each lateral wall comprising a respective straight line segment structure formed of a respective laminated stretched curvature; a top wall; and opposing front wall and rear wall, the front wall and the rear wall being outwardly arched walls respectively connected between the straight line segment structures of the lateral walls and providing an outwardly arched curvature, the front wall and the rear wall being asymmetric.

Further, the lighting device with shaped reflector in accordance with the present invention can be designed for use as a street light, lounge light, signboard light or streamline worktable light, to effectively convert light rays emitted by the light source into luminous rays, lowering power consumption and meeting energy-saving and carbon-reduction requirements.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1A is a schematic drawing of a lighting device according to the prior art.

FIG. 1B is a schematic drawing of another design of lighting device according to the prior art.

FIG. 1C is a schematic drawing of still another design of lighting device according to the prior art.

FIG. 2A is a schematic side view of a shaped reflector for lighting device according to a first example of the present invention.

FIG. 2B is a front view of FIG. 2A.

FIG. 3A is a schematic side view of a shaped reflector for lighting device according to a second example of the present invention.

FIG. 3B is a front view of FIG. 3A.

FIG. 4A is a schematic side view of a shaped reflector for lighting device according to a third example of the present invention.

FIG. 4B is a front view of FIG. 4A.

FIG. 5A is a schematic side view of a shaped reflector for lighting device according to a fourth example of the present invention.

FIG. 5B is a front view of FIG. 5A.

FIG. 6A is a schematic side view of a shaped reflector for lighting device according to a fifth example of the present invention.

FIG. 6B is a front view of FIG. 6A.

FIG. 7A is a schematic side view of a shaped reflector for lighting device according to a sixth example of the present invention.

FIG. 7B is a front view of FIG. 7A.

FIG. 8A is a schematic side view of a shaped reflector for lighting device according to a seventh example of the present invention.

FIG. 8B is a front view of FIG. 8A.

FIG. 9A is a schematic front view of a shaped reflector for lighting device according to an eighth example of the present invention.

FIG. 9B is a schematic front view of a shaped reflector for lighting device according to a tenth example of the present invention.

FIG. 10A is a schematic front view, illustrating one design of through holes on the top wall of the shaped reflector for lighting device in accordance with the present invention.

FIG. 10B is a schematic front view, illustrating another design of through holes on the top wall of the shaped reflector for lighting device in accordance with the present invention.

FIG. 11 is a schematic sectional view of a suspension lighting device embodying the present invention.

FIG. 12 is a schematic sectional view of a street light embodying the present invention.

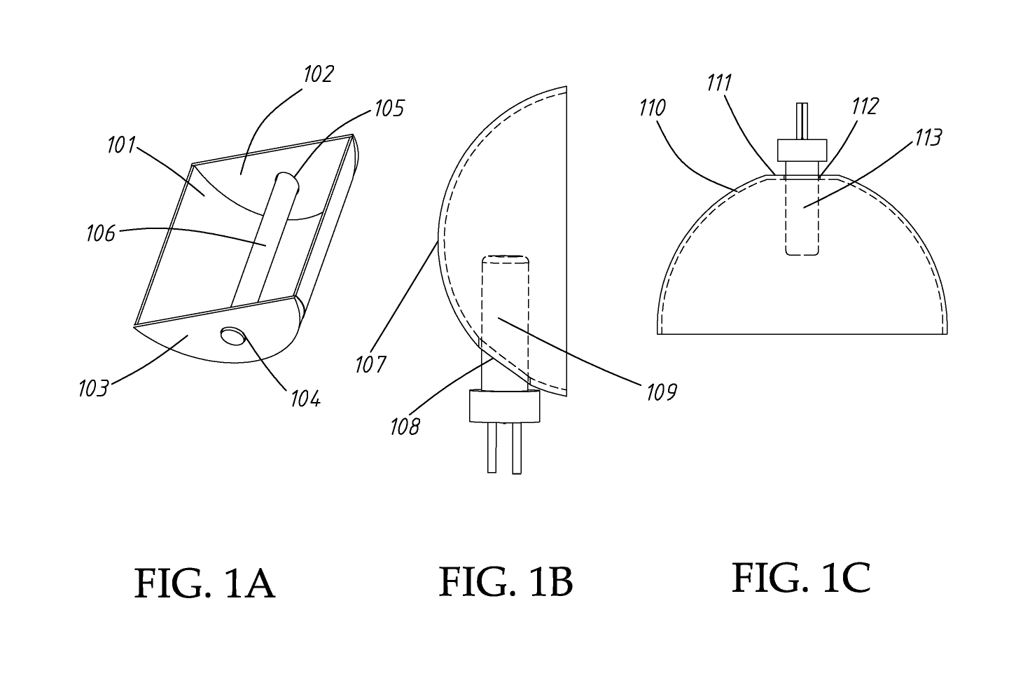

### DETAILED DESCRIPTION OF THE PREFERRED EMBODIMENT

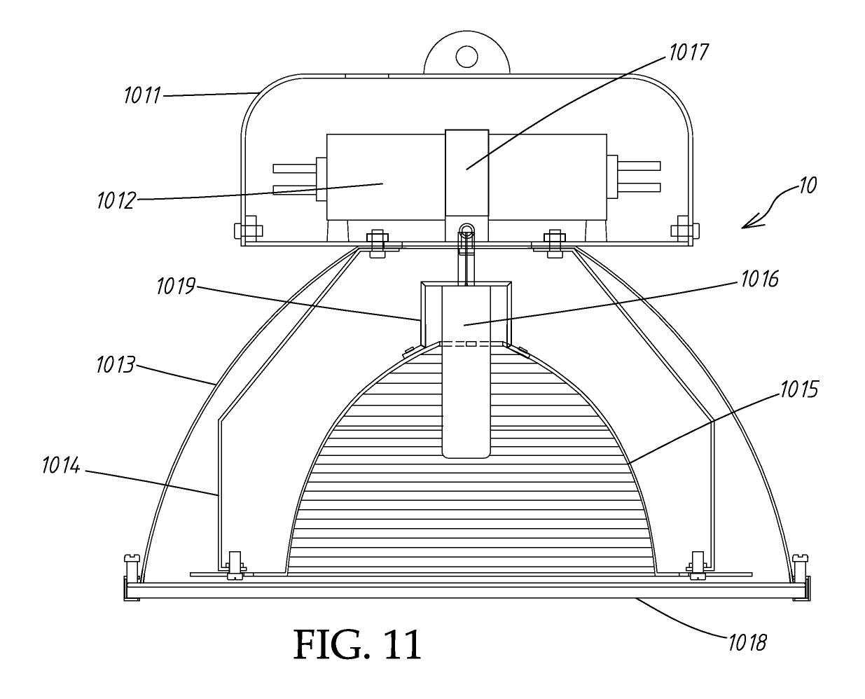

Referring to FIG. 11, a lighting device having a shaped reflector in accordance with the present invention is shown. According to this embodiment, the lighting device is a suspension lighting device 10, comprising an electrical box 1011, a power converter 1012 mounted in the electrical box 1011 and secured to the outwardly extending planar bottom wall of the electrical box 1011 by an iron strap 1017, a dust cover 1013 arranged at the bottom side of the electrical box 1011, a light-transmissive plate member 1018 located on the light-outgoing portion in the bottom side of the dust cover 1013, a bracket 1014 mounted inside the dust cover 1013, a shaped reflector 1015 mounted in the bracket 1014, a lamp tube holder 1019 arranged at the top side of the shaped reflector 1015, and a light source 1016 installed in the lamp tube holder 1019 and suspending in the shaped reflector 1015.

The main feature of the lighting device is the design of the shaped reflector. The shaped reflector is outlined hereinafter.

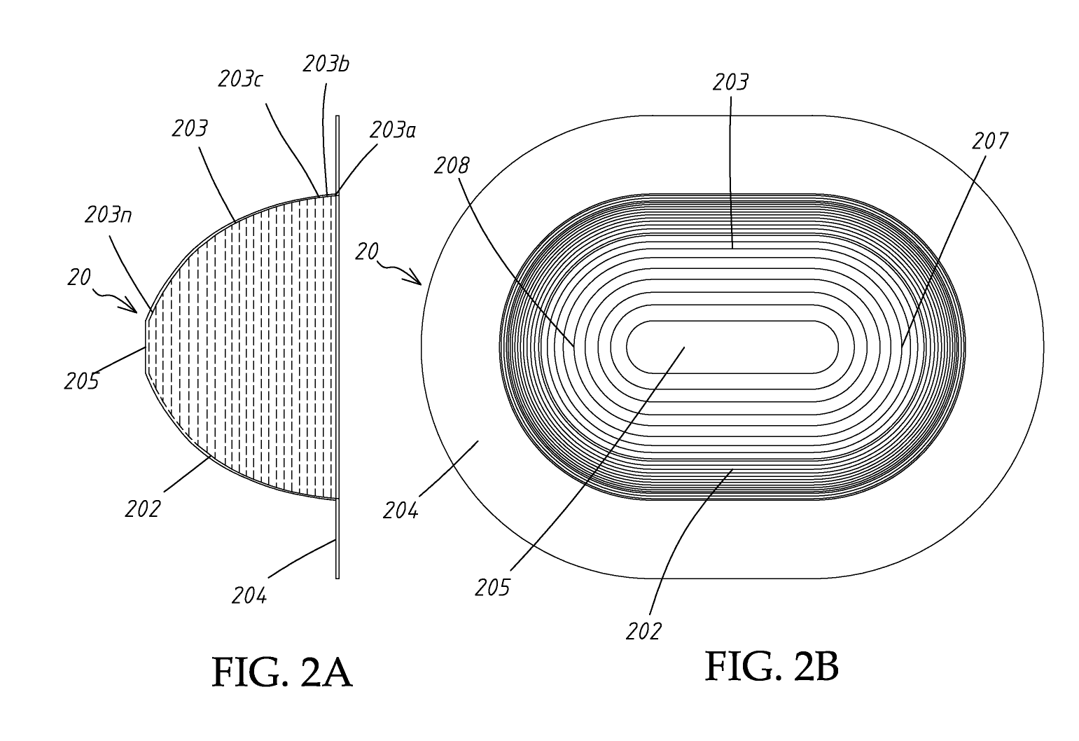

FIGS. 2A and 2B illustrate a first example of the shaped reflector in accordance with the present invention. As illustrated, the inner surface of the shaped reflector 20 is a reflecting surface. The shaped reflector 20 comprises two lateral walls 202;203. One lateral wall 203 consists of a plurality of inclined faces 203a˜203n, providing an outwardly arched curvature. The inclined faces 203a˜203n respectively incline in such a manner that one upper inclined face inclines toward the center of the shaped reflector 20 at a relatively greater angle than the adjacent lower inclined face. The other lateral wall 202 has the same structural feature. The outwardly arched curvature of each of the two lateral walls 202;203 forms a structure of straight line segment, as shown in FIG. 2B. The straight line segments of the two lateral walls 202;203 are symmetric.

Referring to FIG. 2B again, the opposing front and rear walls of the shaped reflector 20 are outwardly arched walls 207;208. These two outwardly arched walls 207;208 are curved from the two straight line segments of the two lateral walls 202;203 in a symmetric but non-concentric manner.

The shaped reflector 20 further comprises a bottom planar wall 204 and a top planar wall 205.

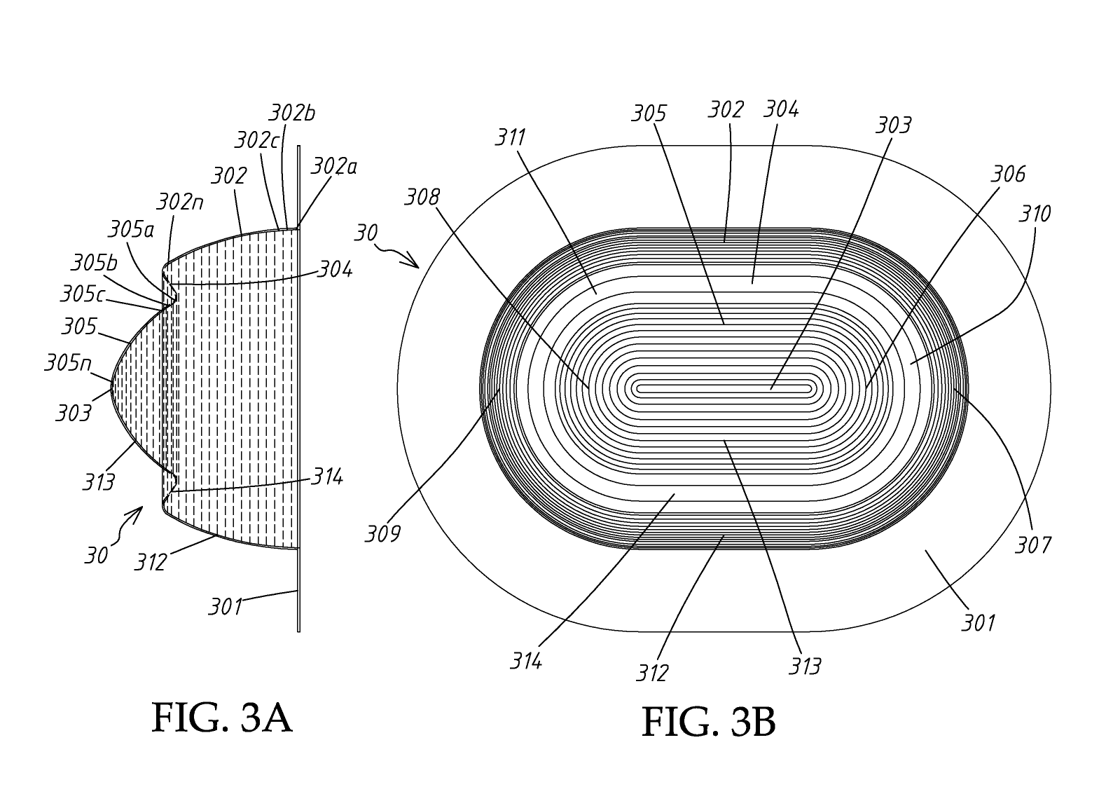

FIGS. 3A and 3B illustrate a second example of the shaped reflector in accordance with the present invention. As illustrated, one lateral wall 303 of the shaped reflector 30 comprises a first stepped straight line segment structure 302, a second stepped straight line segment structure 305, and a slope 304. The first stepped straight line segment structure 302 consists of a plurality of inclined faces 302a˜302n that are configured in such a manner that one upper inclined face inclines toward the center of the shaped reflector 30 at a relatively greater angle than the adjacent lower inclined face. The first stepped straight line segment structure 302 has the top edge thereof connected to an outer edge of slope 304 that slopes toward the bottom side of the shaped reflector 30. The slope 304 has its inner edge connected to the bottom edge of the second stepped straight line segment structure 305.

The second stepped straight line segment structure 305 consists of a plurality of inclined faces 305a˜305n that are configured in such a manner that one upper inclined face incline toward the center of the shaped reflector 30 at a relatively greater angle than the adjacent lower inclined face. The other lateral wall of the shaped reflector 30 also comprises a first stepped straight line segment structure 312, a second stepped straight line segment structure 313, and a slope 314. The first stepped straight line segment structure 302 and the first stepped straight line segment structure 312 are symmetric; the second stepped straight line segment structure 305 and the second stepped straight line segment structure 313 are symmetric.

Referring to FIG. 3B again, the opposing front and rear walls of the shaped reflector 30 are stepped, outwardly arched walls respectively started from a straight line segment structure in a same outwardly arched curvature. The front wall comprises a sector slope 310 connected between two part parts 306;307 thereof. These two stepped, outwardly arched walls are arranged in a symmetric but non-concentric manner.

The shaped reflector 30 further comprises a bottom planar wall 301 and a top planar wall 303.

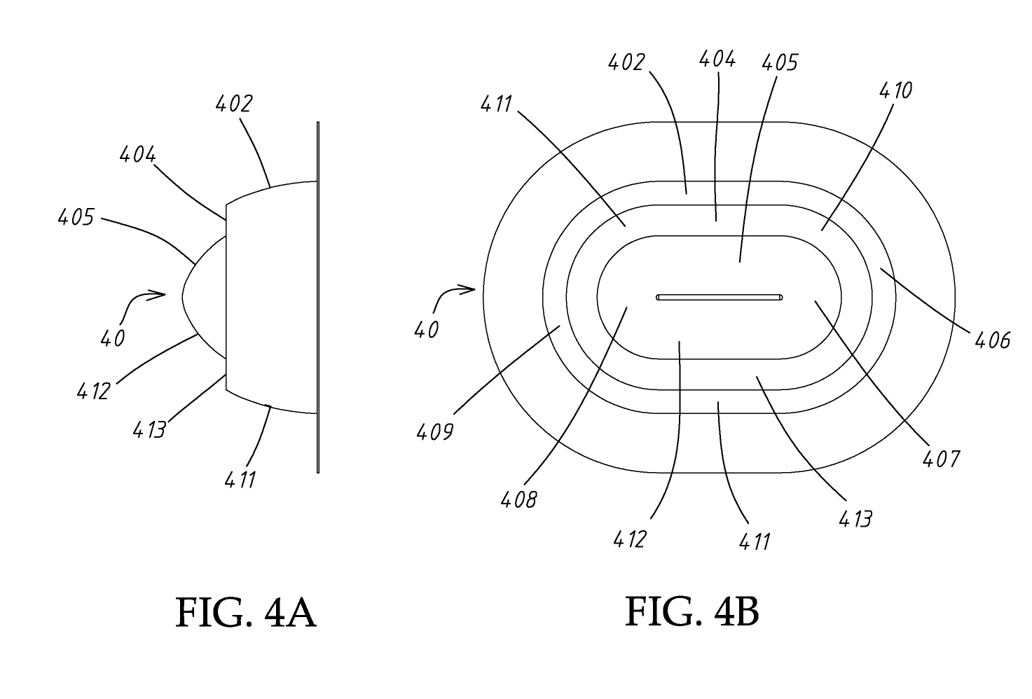

FIGS. 4A and 4B illustrate a third example of the shaped reflector in accordance with the present invention. According to this third example, one lateral wall of the shaped reflector 40 comprises a planar wall 404 is connected between a first stepped straight line segment structure 402 and a second stepped straight line segment structure 405 thereof; the other lateral wall of the shaped reflector 40 comprises a planar wall 413 is connected between a first stepped straight line segment structure 411 and a second stepped straight line segment structure 4112 thereof; the front wall of the shaped reflector 40 comprises a sector plane 410 connected between a first stepped, outwardly arched wall 406 and a second stepped, outwardly arched wall 407 thereof; the rear wall of the shaped reflector 40 comprises a sector plane 411 connected between a first stepped, outwardly arched wall 409 and a second stepped, outwardly arched wall 408 thereof.

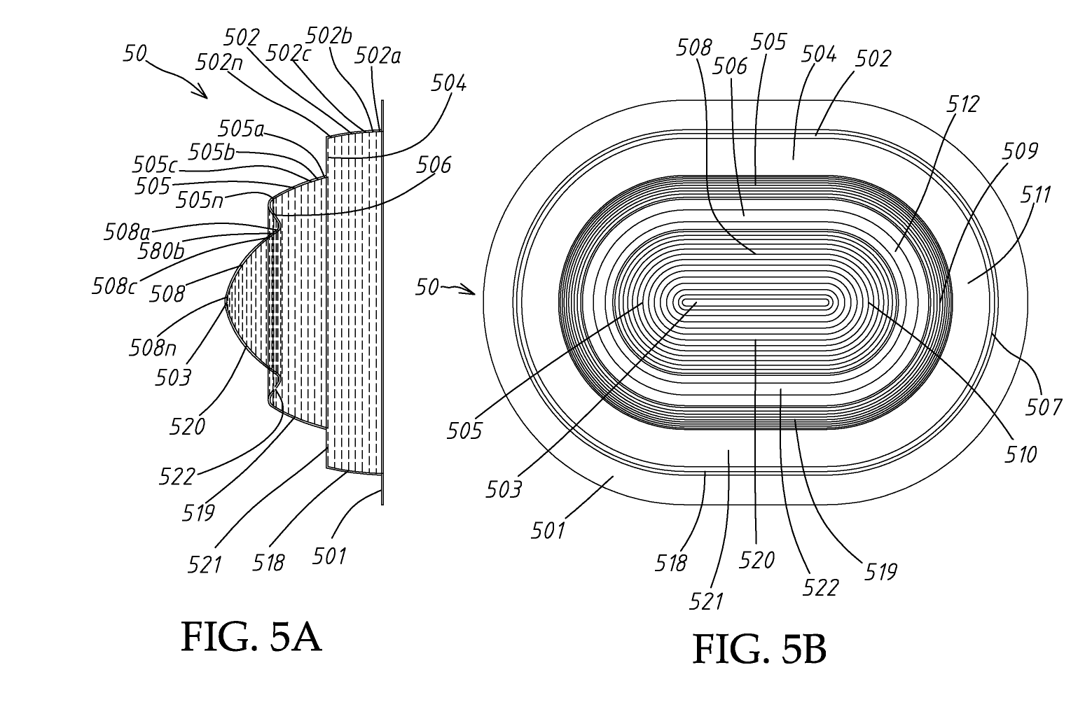

FIGS. 5A and 5B illustrate a fourth example of the shaped reflector in accordance with the present invention. According to this fourth example, each of the two opposing lateral walls of the shaped reflector 50 are outwardly arched walls each consisting of three stepped straight line segment structures. The first stepped straight line segment structure 502 of one lateral wall of the shaped reflector 50 comprises a plurality of inclined faces 502a˜502n that respectively incline in such a manner that one upper inclined face inclines toward the center of the shaped reflector 50 at a relatively greater angle than the adjacent lower inclined face.

The first stepped straight line segment structure 502 has its top edge connected to an outer edge of a planar wall 504, which has its inner edge connected to the bottom edge of the second stepped straight line segment structure 505.

The second stepped straight line segment structure 505 comprises a plurality of inclined faces 505a˜505n that respectively incline in such a manner that one upper inclined face inclines toward the center of the shaped reflector 50 at a relatively greater angle than the adjacent lower inclined face.

The second stepped straight line segment structure 505 has its top edge connected to an outer edge of a slope 506, which slopes downwardly and inwardly toward the center of the shaped reflector, having its inner edge connected to the bottom edge of the third stepped straight line segment structure 506.

The third stepped straight line segment structure 508 comprises a plurality of inclined faces 508a˜508n that respectively incline in such a manner that one upper inclined face inclines toward the center of the shaped reflector 50 at a relatively greater angle than the adjacent lower inclined face. The other lateral wall of the shaped reflector comprises first, second and third stepped straight line segment structures 518;519;520, a planar wall 521 connected between the first stepped straight line segment structure 518 and the second stepped straight line segment structure 519, and a slope 522 connected between the second stepped straight line segment structure 519 and the third stepped straight line segment structure 520. In this example, the two lateral walls of the shaped reflector 50 are symmetric.

Referring to FIG. 5B again, the front and rear walls of the shaped reflector 50 are outwardly arched walls. The front wall of the shaped reflector 50 comprises a first stepped, outwardly arched wall 507, a second stepped, outwardly arched wall 509, a first sector plane 511 connected between the first stepped, outwardly arched wall 507 and the second stepped, outwardly arched wall 509, a third stepped, outwardly arched wall 510, and a second sector plane 512 connected between the second stepped, outwardly arched wall 509 and the third stepped, outwardly arched wall 510. Further, the front wall and rear wall of the shaped reflector 50 are symmetric.

The shaped reflector 50 further comprises a bottom planar wall 501 and a top planar wall 503.

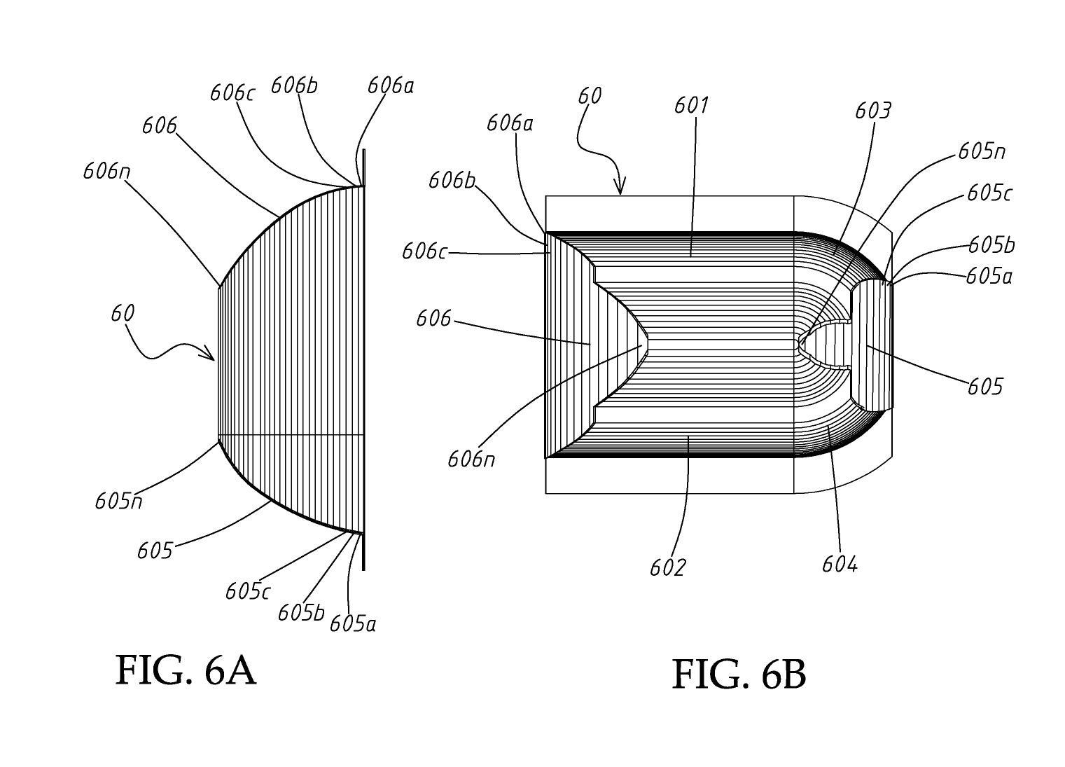

FIGS. 6A and 6B illustrate a fifth example of the shaped reflector in accordance with the present invention. According to this fifth example, the two opposing lateral walls 601;602 of the shaped reflector 60, similar to the lateral walls of the shaped reflector shown in FIGS. 4A and 4B, are outwardly arched walls each consisting of two stepped straight line segment structures. The front wall of the shaped reflector 60 comprises two outwardly arched walls 603;604 and one outwardly arched straight line segment structure 605. The two outwardly arched walls 603;604 respectively extend from the straight line segment structures 601;602 of the lateral walls of the shaped reflector 60 in a same curvature and are joined by the outwardly arched straight line segment structure 605. The outwardly arched straight line segment structure 605 has two opposing side edges thereof respectively connected to the two outwardly arched walls 603;604. The inner reflecting surface of the outwardly arched straight line segment structure 605 consists of a plurality of inclined faces 605a˜605n that respectively incline in such a manner that one upper inclined face inclines toward the center of the shaped reflector 60 at a relatively greater angle than the adjacent lower inclined face. The rear wall of the shaped reflector 60 is an outwardly arched straight line segment structure 606, having two opposing lateral edges thereof respectively connected to the straight line segment structures 601;602 of the lateral walls of the shaped reflector 60. The outwardly arched straight line segment structure 606 consists of a plurality of inclined faces 606a˜606n that respectively incline in such a manner that one upper inclined face inclines toward the center of the shaped reflector 60 at a relatively greater angle than the adjacent lower inclined face.

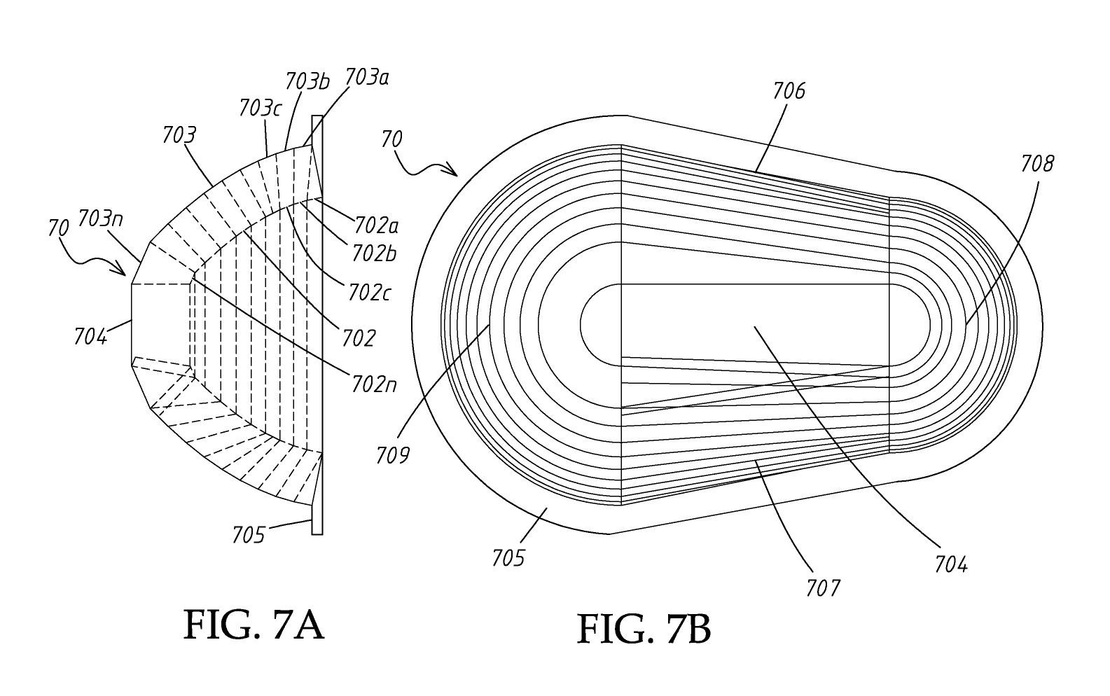

FIGS. 7A and 7B illustrate a sixth example of the shaped reflector in accordance with the present invention. According to this sixth example, the inner surface of the shaped reflector 70 is a reflecting surface, providing two outwardly arched curvatures 702;703. One outwardly arched curvature 702 consists of a plurality of inclined faces 702a;702b;702c;702n that incline at a different angle. The other outwardly arched curvature 703 consists of a plurality of inclined faces 703a;703b;703c;703n that incline at a different angle. All the inclined faces of the outwardly arched curvatures 702;703 incline in such a manner that one upper inclined face inclines toward the center of the shaped reflector 70 at a relatively greater angle than the adjacent lower inclined face. The two opposing lateral walls 706;707 of the shaped reflector 70 each have a laminated stretched straight line segment structure, respectively formed of the outwardly arched curvatures 702;703. These two opposing lateral walls 706;707 can be symmetric, or asymmetric. The opposing front and rear walls 708;709 of the shaped reflector 70 are outwardly arched walls, respectively providing an outwardly arched curvature. Further, the front and rear walls 708;709 are asymmetric.

The shaped reflector 70 further comprises a bottom planar wall 705 and a top planar wall 704.

This sixth example is modification based on the design of FIG. 2. Alternatively any of the outwardly arched curvature designs shown in FIGS. 3 through 6 can be employed to this sixth example.

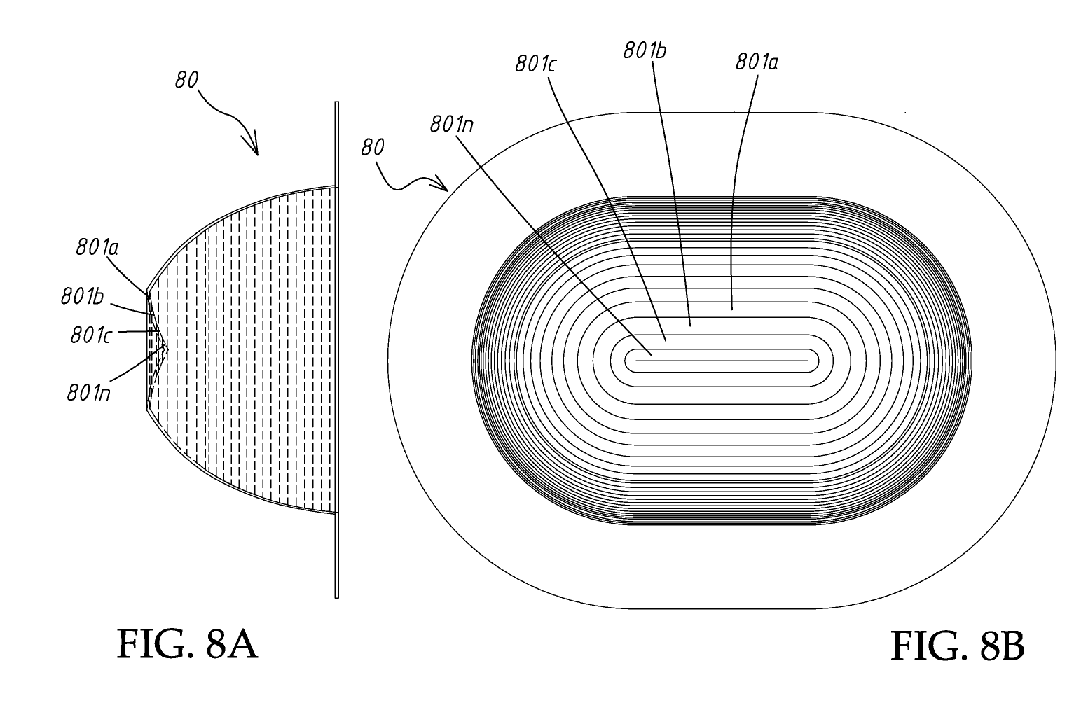

FIGS. 8A and 8B illustrate a seventh example of the shaped reflector in accordance with the present invention. The inner surface of the shaped reflector 80 in accordance with this seventh example is substantially similar to that shown in FIGS. 2A and 2B with the exception that the top wall of the shaped reflector 80 curves inwards, consisting of a plurality of inclined faces 801a;801b;801c;801n that incline in such a manner that one outer inclined face inclines toward the center of the shaped reflector 70 at a relatively greater angle than the adjacent inner inclined face. It is to be understood that the top wall of each of the examples shown in FIGS. 3 through 7 can be an inwardly curved wall.

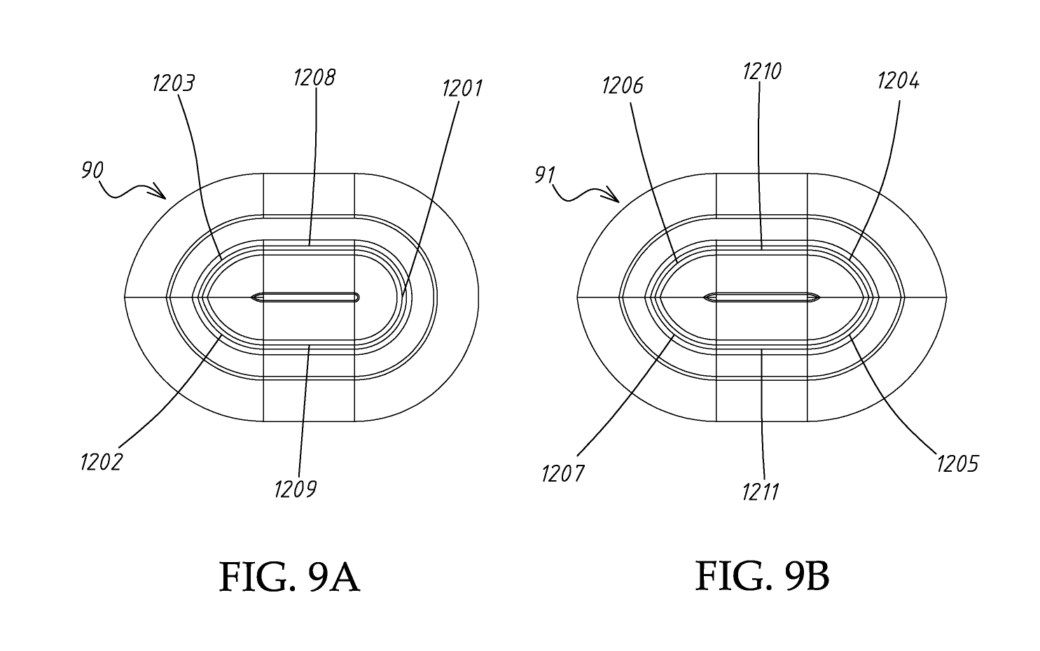

FIG. 9A illustrates a shaped reflector in accordance with an eighth example of the present invention. According to this example, the outwardly arched straight line segment structures of the two opposing lateral walls 1208;1209 of the shaped reflector 90 are similar to that shown in FIGS. 3A and 3B. The front wall of the shaped reflector 90 is an outwardly arched wall 1201 connected between the outwardly arched straight line segment structures of the two opposing lateral walls. The rear wall of the shaped reflector 90 comprises two outwardly arched walls 1202;1203 connected between the outwardly arched straight line segment structures of the two opposing lateral walls in a symmetric but non-concentric manner.

FIG. 9B illustrates a shaped reflector in accordance with a ninth example of the present invention. According to this example, the outwardly arched straight line segment structures of the two opposing lateral walls 1218;1211 of the shaped reflector 90 are similar to that shown in FIGS. 3A and 3B. The front wall of the shaped reflector 91 comprises two outwardly arched walls 1204;1205 connected between the outwardly arched straight line segment structures of the two opposing lateral walls in a symmetric but non-concentric manner. The rear wall of the shaped reflector 91 comprises two outwardly arched walls 1206;1207 connected between the outwardly arched straight line segment structures of the two opposing lateral walls in a symmetric but non-concentric manner.

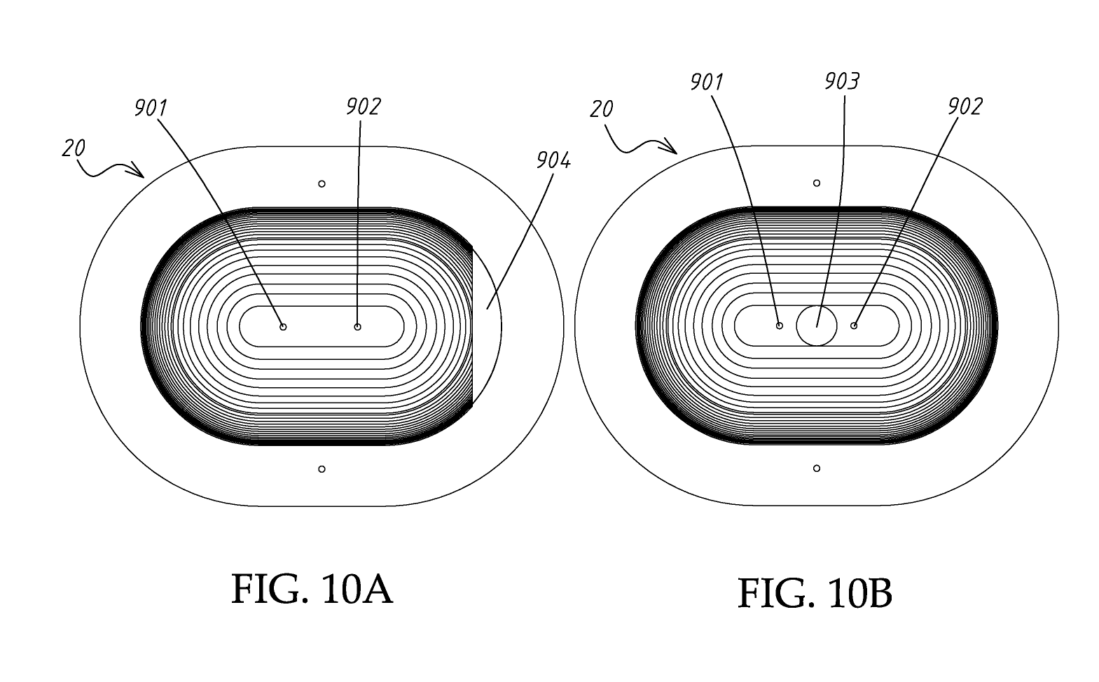

FIGS. 10A and 10B illustrate further two alternate forms of the shaped reflector. The example shown in FIG. 10A is based on the shaped reflector 20 shown in FIG. 2, having a through hole 904 cut through the front wall for the passing of the light source (lamp tube), and two through holes 901;902 cut through the top wall for the mounting of the lamp bracket. The example shown in FIG. 10B is based on the shaped reflector 20 shown in FIG. 2, having a big through hole 903 cut through the front wall for the passing of the light source (lamp tube), and two small through holes 901;902 cut through the top wall at two opposite sides relative to the big through hole 903 for the mounting of the lamp bracket. The shaped reflector constructed subject to any of the examples shown in FIGS. 3 through 9 can provide similar through holes for mounting.

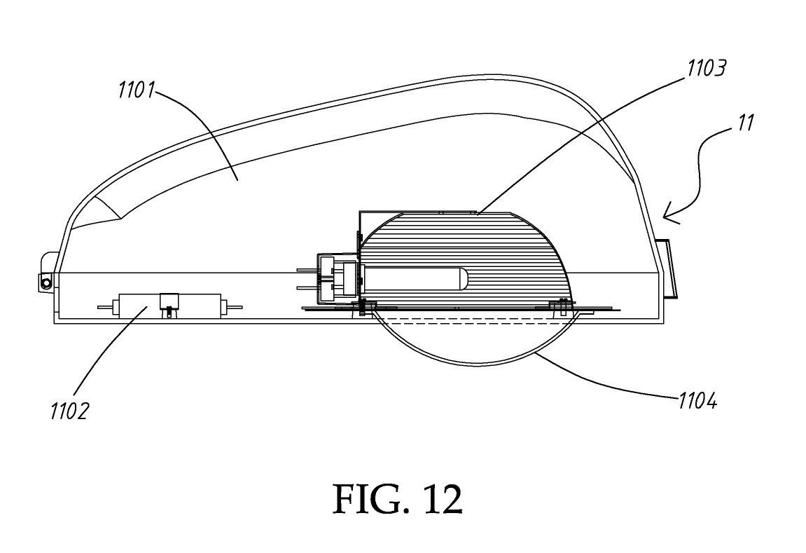

FIG. 12 illustrates a street light 11 embodying the present invention. As illustrated, the street light 11 comprises a lamp case 1101, a power converter 1102 mounted in the lamp case 1101, a light-transmissive plate member 1104 located on the bottom side of the lamp case 1101, and a shaped reflector 1103 mounted on the light-transmissive plate member 1104 inside the lamp case 1101 and holding a light source therein.

The lighting device with shaped reflector in accordance with the present invention can be designed for use as a street light, lounge light, signboard light or streamline worktable light, to effectively convert light rays emitted by the light source into luminous rays, lowering power consumption and meeting energy-saving and carbon-reduction requirements.

In the aforesaid various alternate forms of the present invention, the inner reflecting surface of the shaped reflector provides one or a limited number of outwardly arched curves each consisting of a plurality of faces that incline at different angles of inclination. In actual practice, each line segment of each outwardly arched curve can be composed of a plurality of sub-segments.

Further, the light source of the lighting device constructed according to the embodiment shown in FIG. 11 or FIG. 12 can be a LED light source formed of one or a number of LED chips.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lighting device, comprising: a light source adapted to emit light; and a shaped reflector mounted in said light source for reflecting light emitted by said light source toward a predetermined space area;
wherein said shaped reflector comprises:
an inner reflecting surface comprising a first stepped, outwardly arched curvature, a second stepped, outwardly arched curvature and a planar wall connected between said first stepped, outwardly arched curvature and said second stepped, outwardly arched curvature, said first stepped, outwardly arched curvature and said second stepped, outwardly arched curvature each comprising a plurality of inclined faces, the inclined faces of said first stepped, outwardly arched curvature inclining in such a manner that one upper inclined face inclines toward the center of said shaped reflector at a relative greater angle than one adjacent lower inclined face, the inclined faces of said second stepped, outwardly arched curvature inclining in such a manner that one upper inclined face inclines toward the center of said shaped reflector at a relative greater angle than one adjacent lower inclined face;
two opposing lateral walls, each said lateral wall comprising a straight line segment structure formed of a plurality of stepped, outwardly arched curvatures and a connection wall connected between each two adjacent stepped outwardly arched curvatures;
a planar top wall; and
opposing front wall and rear wall, said front wall and said rear wall being stepped, outwardly arched walls respectively connected between the straight line segment structures of said lateral walls, said front wall and said rear wall being stepped, outwardly arched walls each comprising a straight line segment structure formed of a plurality of stepped, outwardly arched curvatures and a connection wall connected between each two adjacent stepped outwardly arched curvatures.

2. The lighting device as claimed in claim 1, further comprising:
a power converter adapted to provide electricity to said light source;
a dust cover surrounding said shaped reflector, said dust cover defining a light-outgoing port in a bottom side thereof; and
a light-transmissive plate member covering said light-outgoing port.

3. The lighting device as claimed in claim 1, wherein each said connection wall of each of said two opposing lateral walls of said shaped reflector is an inwardly inclined face; the connection wall of each of said front wall and rear wall is an inwardly inclined sector slope.

4. The lighting device as claimed in claim 1, wherein said shaped reflector further comprises a top wall consisting of a plurality of inclined faces that incline in such a manner that one outer inclined face inclines toward the center of said shaped reflector at a relatively greater angle than the adjacent inner inclined face.

5. The lighting device as claimed in claim 1, wherein said two opposing lateral walls of said shaped reflector each comprise a first straight line segment structure, a second straight line segment structure, a planar wall connected between the first straight line segment structure and the second straight line segment structure, a third straight line segment structure and an inwardly inclined slope connected between the second straight line segment structure; said front wall and rear wall of said shaped reflector each comprise a first straight line segment structure, a second straight line segment structure, an outwardly arched sector plane connected between the first straight line segment structure and the second straight line segment structure, a third straight line segment structure and an inwardly arched sector plane connected between the second straight line segment structure and the third straight line segment structure.

6. The lighting device as claimed in claim 1, wherein said front wall of said shaped reflector consists of two outwardly arched planes and an outwardly arched straight line segment structure; said rear wall of said shaped reflector is an outwardly arched straight line segment structure.

7. The lighting device as claimed in claim 1, wherein said shaped reflector further comprises an outwardly extending planar bottom wall, a big through hole cut through said outwardly extending planar bottom wall for the passing of a lamp tube of said light source, and two small through holes cut through said outwardly extending planar bottom wall at two opposite sides relative to said big through hole for the mounting of screws and nuts to secure a bracket for holding said lamp tube.

8. The lighting device as claimed in claim 1, wherein said shaped reflector further comprises an outwardly extending planar bottom wall, a through hole cut through said front wall for the passing of a lamp tube of said light source, and two small through holes cut through said planar top wall for the mounting of a bracket for holding said lamp tube.

9. A lighting device, comprising: a light source adapted to emit light; and a shaped reflector mounted in said light source for reflecting light emitted by said light source toward a predetermined space area;
wherein said shaped reflector comprises:
an inner reflecting surface comprising an outwardly arched curvature consisting of a plurality of inclined faces, the inclined faces of said inner reflecting surface inclining in such a manner that one upper inclined face inclines toward the center of said shaped reflector at a relative greater angle than one adjacent lower inclined face;
two opposing lateral walls, each said lateral wall comprising a straight line segment structure formed of said outwardly arched curvature;
a top wall; and
opposing front wall and rear walls, said front wall and said rear wall being outwardly arched walls respectively connected between the straight line segment structures of said lateral walls and providing an outwardly arched curvature.

10. The lighting device as claimed in claim 9, further comprising:
a power converter adapted to provide electricity to said light source;
a dust cover surrounding said shaped reflector, said dust cover defining a light-outgoing port in a bottom side thereof; and
a light-transmissive plate member covering said light-outgoing port.

11. The lighting device as claimed in claim 9, wherein said top wall curves inwardly, comprising a plurality of inclined faces inclining in such a manner that one outer inclined face inclines at a relatively greater angle relative to one adjacent inner inclined face.

12. The lighting device as claimed in claim 9, wherein said front wall of said shaped reflector consists of two outwardly arched faces and an outwardly arched straight line segment structure; said rear wall of said shaped reflector is formed of an outwardly inclined straight line segment structure.

13. The lighting device as claimed in claim 10, wherein said shaped reflector further comprises an outwardly extending planar bottom wall, a plurality of through holes cut through said outwardly extending planar bottom wall for the mounting of screws and nuts to secure a bracket inside said dust cover, a big through hole cut through said top wall for the passing of a lamp tube of said light source, and two small through holes cut through said top wall at two opposite sides relative to said big through hole for securing said bracket.

14. The lighting device as claimed in claim 10, wherein said shaped reflector further comprises an outwardly extending planar bottom wall, a through hole cut through said front wall for the passing of a lamp tube of said light source, and two small through holes cut through said top wall for the mounting of a bracket for holding said lamp tube.

15. A lighting device, comprising: a light source adapted to emit light; and a shaped reflector mounted in said light source for reflecting light emitted by said light source toward a predetermined space area;
wherein said shaped reflector comprises:
an inner reflecting surface comprising an outwardly arched curvature consisting of a plurality of inclined faces, the inclined faces of said inner reflecting surface inclining in such a manner that one upper inclined face inclines toward the center of said shaped reflector at a relative greater angle than one adjacent lower inclined face;
two opposing lateral walls, each said lateral wall comprising a respective straight line segment structure formed of a respective laminated stretched curvature;
a top wall; and
opposing front wall and rear wall, said front wall and said rear wall being outwardly arched walls respectively connected between the straight line segment structures of said lateral walls and providing an outwardly arched curvature, said front wall and said rear wall being asymmetric.

16. The lighting device as claimed in claim 15, further comprising:
a power converter adapted to provide electricity to said light source;
a dust cover surrounding said shaped reflector, said dust cover defining a light-outgoing port in a bottom side thereof; and
a light-transmissive plate member covering said light-outgoing port.

17. The lighting device as claimed in claim 15, wherein said top wall curves inwardly, comprising a plurality of inclined faces inclining in such a manner that one outer inclined face inclines at a relatively greater angle relative to one adjacent inner inclined face.

18. The lighting device as claimed in claim 16, wherein said shaped reflector further comprises an outwardly extending planar bottom wall, a plurality of through holes cut through said outwardly extending planar bottom wall for the mounting of screws and nuts to secure a bracket inside said dust cover, a big through hole cut through said top wall for the passing of a lamp tube of said light source, and two small through holes cut through said top wall at two opposite sides relative to said big through hole for securing said bracket.

19. The lighting device as claimed in claim 15, wherein said front wall of said shaped reflector consists of two outwardly arched faces and an outwardly arched straight line segment structure; said rear wall of said shaped reflector is formed of an outwardly inclined straight line segment structure.

20. The lighting device as claimed in claim 15, wherein said shaped reflector further comprises an outwardly extending planar bottom wall, a through hole cut through said front wall for the passing of a lamp tube of said light source, and two small through holes cut through said top wall for the mounting of a bracket for holding said lamp tube.
